(19) United States
(12) Patent Application Publication
(10) Pub. No.: US 2015/0360379 A1
(43) Pub. Date: Dec. 17, 2015

(54) AXE

(71) Applicant: Estwing Manufacturing Company, Inc., Rockford, IL (US)

(72) Inventors: Joshua D. West, Rockford, IL (US); Paul Youngren, Rockford, IL (US); Mark Youngren, Oregon, IL (US); Robert H. Youngren, Stillman Valley, IL (US); John W. Ryan, JR., Belvidere, IL (US)

(73) Assignee: Estwing Manufacturing Company, Inc., Rockford, IL (US)

(21) Appl. No.: 14/302,991

(22) Filed: Jun. 12, 2014

(51) Int. Cl. B26B 23/00; B26B 3/00; B26B 29/00

(52) U.S. Cl. CPC B26B 23/00; B26B 29/00; B26B 3/00

(57) ABSTRACT

Axes are disclosed herein that include a handle having a first end, a second end, and a longitudinal axis. A head is disposed on the second end of the handle and includes a first cutting edge having a first chord with an angle of about 45° or less from the longitudinal axis. The axes further include a second cutting edge having a second chord. The second cutting edge is capped at an outer end thereof with a blunt tip.

### CROSS REFERENCE TO RELATED APPLICATIONS

Not Applicable

### REFERENCE REGARDING FEDERALLY SPONSORED RESEARCH OR DEVELOPMENT

Not Applicable

### SEQUENCE LISTING

Not Applicable

### BACKGROUND OF THE INVENTION

1. Field of the Background

The present invention relates generally to axes, and more specifically, to axes useful for cleaning game animals.

2. Description of the Background

Typically an individual hunter requires several tools when hunting and cleaning game animals. Some of these tools may include one or more knives, an axe or hatchet, a bone saw, and a gut hook. Often, the hunter must carry each of these tools into the field, which is difficult due to their weight, size, and number.

In an attempt to overcome this problem, numerous iterations of combination tools have been designed. For example, a combination hand axe and saw includes an elongated handle provided at one end with a hand grip. The handle and the hand grip have a continuous groove, and a saw blade positioned in the groove, the saw blade being pivoted to the handle near the outer end thereof. The saw blade, when in an operative position, has its free end positioned in the groove in the hand grip, the groove in the hand grip being curved about the pivot of the saw, and a stop for limiting the outward movement of the saw in the hand grip groove. The saw blade is foldable into the groove in the handle so as to be entirely within the outlines thereof. The tool further includes means for latching the blade in both its operative and inoperative positions.

Another example is a one-piece game field dressing tool that is utilized to dress both small and large game in the field. The tool is fabricated from a suitable rugged metal, such as stainless steel. The tool comprises an elongate handle and a head. The head incorporates a plurality of surface areas (e.g., a cutting edge and a gut hook) adapted to perform different field dressing tasks. A threaded hole is provided in the handle to permit the tool to be converted to a hatchet by threading a piece of wood therein. However, combination tools, such as these, tend to suffer from being poorly designed and inadequately durable to withstand repeat use and further require some manipulation or assembly before being able to be used in all manners intended.

Another type of combination tool employs the strategy of having a tool held within a cavity of another tool. For example, an axe is provided with an open cavity in a handle for receiving a removably secured secondary tool, such as a knife. A securing assembly includes a spring biased projecting member extending from the secondary tool passing through a hole in the axe handle. The securing assembly maintains the tool in the axe handle while permitting its easy release. The axe handle is made of a lightweight, high strength material such as fiberglass reinforced nylon. Yet, these types of combination tools also have their limitations, such as requiring an extra step to access the tool within the cavity. Furthermore, the cavities are difficult to clean, which presents a significant problem in the context of cleaning game animals.

There is a need, therefore, for a durable, convenient, and easy to clean combination hunter's tool that overcomes the shortcomings of the prior art.

### SUMMARY OF THE INVENTION

According to one aspect, an axe includes a handle having a first end, a second end, and a longitudinal axis. The axe further includes a head disposed on the second end. The head includes a first cutting edge having a first chord having an angle of about 45° or less from the longitudinal axis. The axe also includes a second cutting edge having a second chord having an angle of between about 45° to about 135° from the longitudinal axis. The second cutting edge is capped at an outer end thereof with a blunt tip.

According to another aspect, an axe includes a handle having a first end, a second end, and a longitudinal axis. The axe further includes a head disposed on the second end integral with the handle. The head includes a first cutting edge having a first chord with an angle of about 45° or less relative to the longitudinal axis and a second cutting edge having a second chord with an angle of between about 45° and about 135° relative to the longitudinal axis. The first chord has a length L_{cm1} measured between a first end and a second end of the first cutting edge of about 2.5 to about 15 centimeters, and the second chord has a length G_{L} between a first end and a second end of the second cutting edge ranging from about 0.25 L_{cm1} to about 0.7 L_{cm1}.

According to a further aspect, an axe includes a handle having a first end, a second end, a longitudinal axis, and a saw along one side thereof. The axe further includes a head disposed on the second end. The head includes a first cutting edge having a first chord with an angle of about 45° or less relative to the longitudinal axis and a second cutting edge having a second chord with an angle of between about 45° and about 135° relative to the longitudinal axis.

### BRIEF DESCRIPTION OF THE DRAWINGS

Other aspects and advantages of the present invention will become apparent upon reading the following detailed description and upon reference to the drawings in which:

FIG. 1 is a perspective view of an axe according to one embodiment;

FIG. 2 is a partial, right side elevational schematic view of the axe of FIG. 1;

FIG. 2A is a partial view of the axe head of FIG. 2 illustrating one use of the axe;

FIG. 3 is a partial, front elevational view of the axe of FIG. 1;

FIG. 4 is a partial, rear elevational view of the axe of FIG. 1;

FIG. 5 is a top plan view of the axe of FIG. 1;

FIG. 6 is a partial, right side elevational view of an axe head according to another embodiment;

FIG. 7 is a partial, right side elevational view of an axe head according to a further embodiment;

FIG. 8 is a partial, right side elevational view of an axe head according to yet another embodiment;

FIG. 9 is a partial, right side elevational view of an axe head according to another embodiment;

FIG. 10 is a partial, right side elevational view of an axe head according to a further embodiment;

FIG. 11 is a partial, right side elevational view of an axe head according to yet another embodiment;

FIG. 12 is a partial, right side elevational schematic view of an axe according to a further embodiment; and

FIG. 13 is a partial, right side elevational schematic view of an axe according to another embodiment.

### DETAILED DESCRIPTION OF THE INVENTION

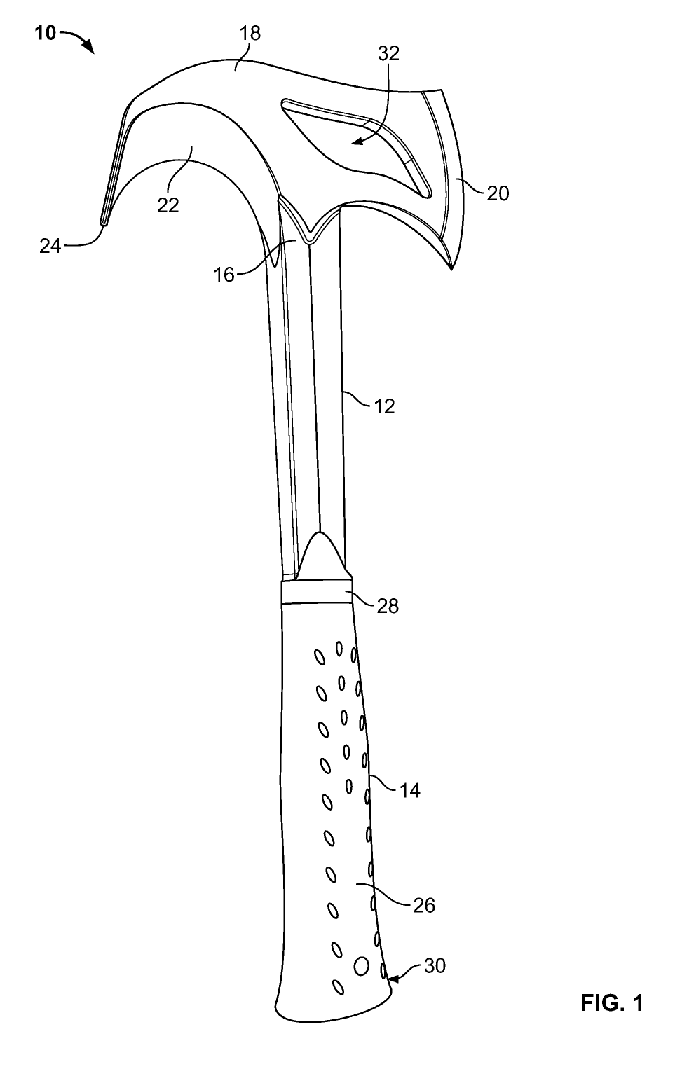

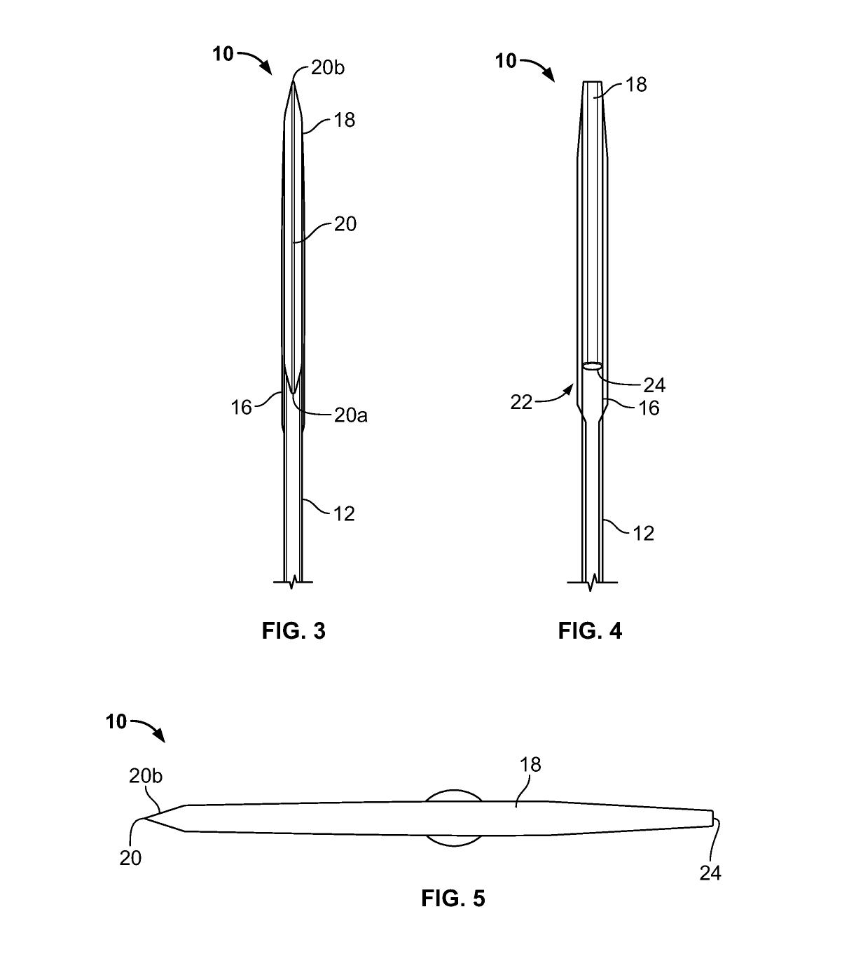

As depicted in FIGS. 1-5, an axe 10 of the present disclosure generally includes a handle 12 having a first end 14 and a second end 16. A head 18 is disposed on the second end 16 and may be either affixed to the handle 12 by means known in the art, such as welding, a friction fit, and the like, or may be integral therewith. In one preferred embodiment, the handle 12 and head 18 are formed from a single piece of steel or other metal. The head 18 may include a first cutting edge 20 on one side thereof and a second cutting edge 22 on an opposite side. A blunt tip 24 is located adjacent an outer edge 22a of the second cutting edge 22 and extends beyond the second cutting edge to effectively cap the second cutting edge and limit access thereto.

A grip 26 is disposed on the first end 14 opposite the head 18. The grip 26 may be disposed adjacent a collar 28 that may serve as a dam during injection molding of the grip when the grip is made from a moldable material or a stop when the grip is assembled on the handle 12, such as with leather pieces (not shown). A grip aperture 30 may be included to allow a cord, rope, or other device to be attached to the handle 12 at the first end 14.

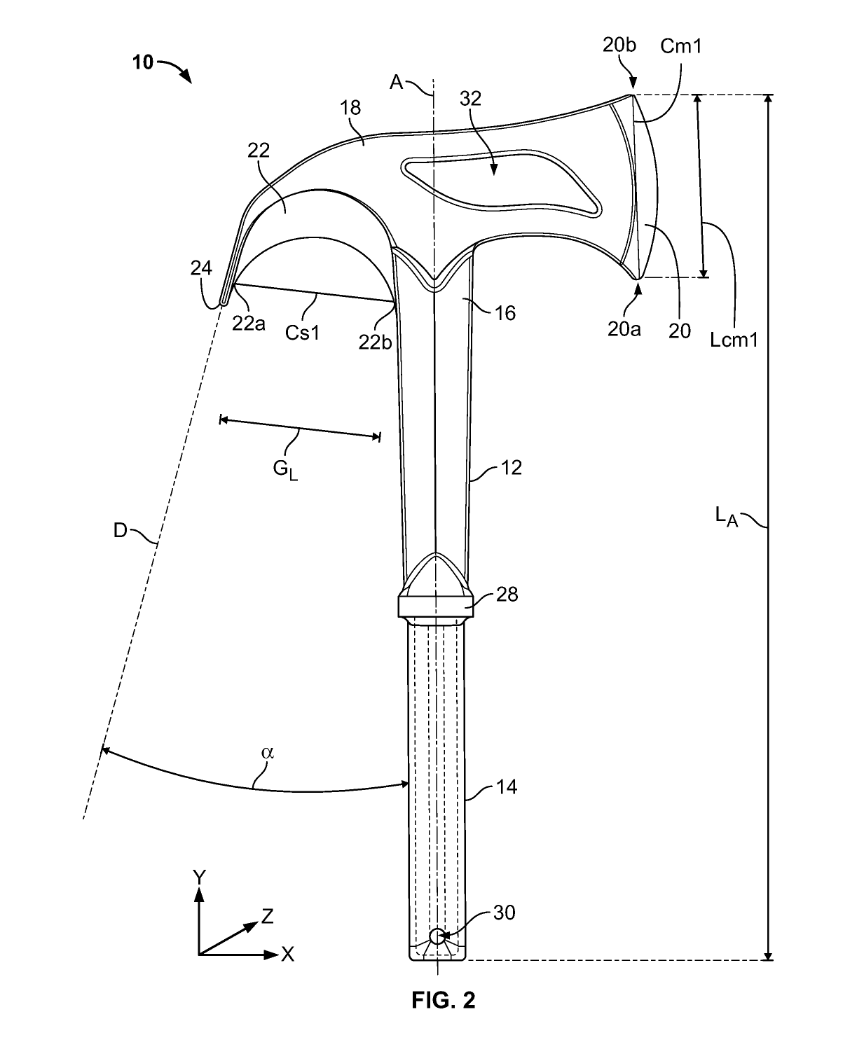

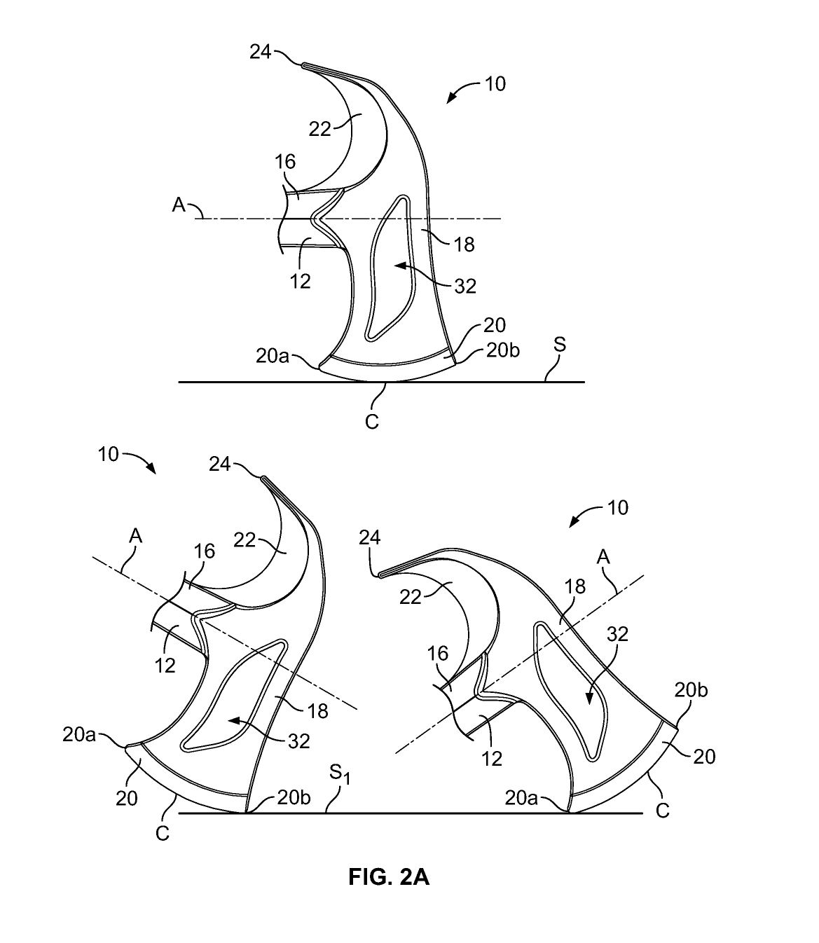

The head 18 may include an aperture 32 extending therethrough to reduce the weight of the head and improve balance of the axe 10. Further, the aperture 32 may be sized to permit a user to grasp the axe 10 by the head 18 by inserting fingers through the aperture. In this way, when the axe 10 is carried in a tool holder (not shown), the user may more easily lift the axe from the tool holder for use. Similarly, the aperture 32 may be used to hang the axe 10 from a hook or similar device for storage. As seen in FIG. 2, the handle 12 further includes a longitudinal axis A that extends through the center of the handle and traverses both the grip aperture 30 and the aperture 32 in the head.

The axe 10 may have an overall length L_{A} from the first end 14 to the second end 16 ranging from about 15 centimeters (cm) to about 90 cm, or about 30 cm to about 60 cm, or a length of about 30 cm, or about 45 cm, or about 50 cm.

The first cutting edge 20 may have a generally convex rounded edge. In one embodiment, the first cutting edge 20 may have a radius of greater than about 2.5 cm, or greater than about 5 cm, or greater than about 10 cm, or greater than about 50 cm. In another embodiment, the first cutting edge 20 has a flat edge (not shown). The first cutting edge 20 when rounded may have a major chord Cₘ₁, which is measured from a lower most edge 20a to an upper most edge 20b, or in other words, equals the maximal cutting length of the first cutting edge. The major chord Cₘ₁ may be parallel to the longitudinal axis A or may be angled with respect thereto. For example, the major chord Cₘ₁ may be angled about 45°, or about 30°, or about 15° or less relative to the longitudinal axis A. In one embodiment, when the major chord Cₘ₁ is angled with respect to the longitudinal axis A, an extension of the major chord Cₘ₁ may intersect the longitudinal axis A at a point above the head 18. Alternatively, the angled major chord Cₘ₁, when extended, may intersect the longitudinal axis at a point below the head 18.

The major chord Cₘ₁ may have a length L_{cm1} ranging from about 2.5 cm to about 15 cm, or about 4 cm to about 12 cm, or about 8 cm to about 10 cm, or a length L_{cm1} of about 6 cm, or about 7 cm, or about 8 cm, or about 10 cm, or about 14 cm.

One advantage of having a rounded cutting edge for the first cutting edge 20 is that it allows for greater variation in strike angle. For example, when a user strikes a horizontal surface from above at an ideal height, a center point C of the first cutting edge 20 strikes the surface (FIG. 2A top), and the longitudinal axis A of the handle 12 is parallel with the strike plane S (i.e., a strike angle of 0°). Further, the handle 12 is typically about 90° relative to the user's forearm, which is approximately vertical (not shown). A rounded first cutting edge 20 permits the user to effectively strike a strike plane S₁ above or below the ideal height, for example, such that the longitudinal axis A of the handle 12 may be angled about 15°, or about 30°, or about 45° or so from the strike plane (see FIG. 2A bottom). Similarly, by angling the major chord Cₘ₁ relative to the longitudinal axis A, the strike angle may be expanded for striking above or below the ideal strike height of the user (not shown).

The second cutting edge 22 may be generally concave and may have a generally smaller radius than the first cutting edge 20, though it may be the same or greater. For example, the second cutting edge 22 may have a radius ranging from about 1 cm to about 15 cm, or about 4 cm to about 12 cm, or about 8 cm to about 10 cm, or a radius of about 1 cm, or about 3 cm, or about 5 cm, or about 7 cm, or about 10 cm. When the second cutting edge 22 has a curved edge, it may have a major chord Cₛ₁, which is measured from an outer most edge 22a to an inner most edge 22b adjacent the handle 12. The major chord Cₛ₁ equals the maximal cutting length of the second cutting edge 22. The major chord Cₛ₁ is angled with respect to the longitudinal axis A. For example, the major chord Cₛ₁ may be angled by about 45° to about 135°, or about 60° to about 120°, or about 80° to about 100° relative to the longitudinal axis A. In one embodiment, the major chord Cₛ₁ is angled about 90° relative to the longitudinal axis A.

The major chord Cₛ₁ may have a length G_{L} that may be expressed as a multiple of the length of the major chord L_{cm1}. For example, G_{L} may have a length of about 0.1 L_{cm1} to about 1 L_{cm1}, or about 0.25 L_{cm1} to about 0.7 L_{cm1}, or about 0.4 L_{cm1} to about 0.6 L_{cm1}, or a length G_{L} of about 0.3 L_{cm1}, or about 0.5 L_{cm1}, or about 0.7 L_{cm1}.

In one embodiment, a ratio of the overall length of the axe L_{A} to the length G_{L} may range from about 2 to about 40, or from about 10 to about 30, or about 15 to about 20, or may be about 5, or about 10, or about 15, or about 20, or about 25, or about 50. In another embodiment, a ratio of the length L_{cm1} to the length G_{L} may range from about 2 or greater, or about 4 or greater, or about 10 or greater, or may be about 1 or about 2, or about 4, or about 6, or about 8.

In one embodiment, a relatively large second cutting edge 22 compared to the first cutting edge (e.g., ratios of L_{cm1} to G_{L} of about 1 or about 2, or about 4) is advantageous. For instance, a relatively large second cutting edge 22 serves to counterbalance the head 18 for a more stable swing by reducing the amount of twist of the head when swung.

The second cutting edge 22 may be employed as a “gut hook” to aid in the field dressing of a game animal, such as a deer, a boar, an elk, a moose, and the like. When so employed, the relatively large size of the second cutting edge 22 compared to other gut hooks is advantageous for many reasons. First, due to the relative size of the second cutting edge 22, a user may continue using the edge as a gut hook longer than conventional gut hooks because the edge dulls in stages. In use, a user may puncture the animal skin or hide (not shown) with the first cutting edge 20, the blunt tip 24, or another tool and insert the blunt tip through the puncture beneath the hide (not shown). As the user draws the second cutting edge 22 down the length of the animal to cut the hide, the blunt tip 24 leads the second cutting edge and lifts the hide with cutting or piercing it to meet the outer most edge 22a to cut the hide. Therefore, over time, the outer most edge 22a dulls first due to first use. However, because of the large size and curvature of the second cutting edge 22, the dulled outer most edge 22a simply lifts the hide farther up the edge toward the center until it reaches a sharp portion that cuts the hide.

Second, typical gut hooks require specialized sharpeners that have very narrow widths because of the constricting size of gut hooks. In contrast, the relatively large size of the second cutting edge 22 allows for much easier sharpening of the edge due to easier access, as well as allowing for a broader range of sharpening tools to be used. Thus, the need for a specialized gut hook sharpener is removed. Third, the relatively large size of the second cutting edge 22 further permits a user to skin the animal, thus reducing the need for a separate tool for this task.

Characteristics of the blunt tip 24 aid in the use of the second cutting edge 22 as a gut hook. To begin with, the blunt tip 24 may have a generally rounded rod-like shape that resists ripping or cutting animal hide. It is further envisioned that the blunt tip 24 may be slightly pointed at the tip such that a user may use the blunt tip to puncture the animal hide to begin field dressing the animal. Further, the angle of the blunt tip 24 relative to the longitudinal axis A of the handle 12 facilitates the use of the second cutting edge 22 as a gut hook. For example, as shown in FIG. 2, a slight angle away from the longitudinal axis A (an open angle) creates a greater clearance between the handle 12 and the animal (a surface of which is represented by dashed line D) during field dressing. The blunt tip 24 may have an angle a measuring about 0° to about 45°, or about 10°, or about 20°, or about 30°, or about 40° relative to the longitudinal axis A.

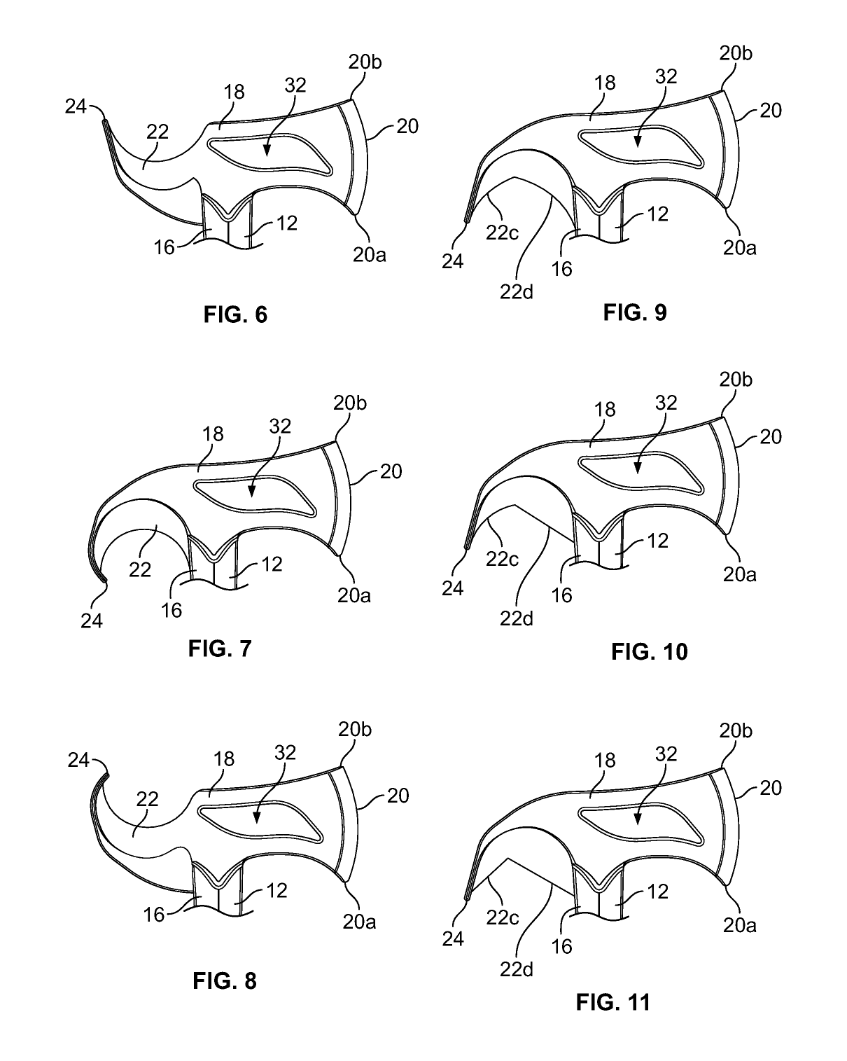

In further embodiments shown in FIGS. 6-11, variations of the second cutting edge 22 and blunt tip 24 are shown. For example, FIG. 6 illustrates a variation of the axe 10 seen in FIGS. 1-5, where the second cutting edge 22 and blunt tip 24 are flipped 180°. In this embodiment, a user may employ the second cutting edge 22 as a gut hook by either pushing the handle 12 in a direction generally along the longitudinal axis A or using the aperture 32 as a grip to pull the axe 10 toward herself. FIG. 7 illustrates a variation of the axe 10 from FIGS. 1-5 where the blunt tip 24 is angled toward the handle 12 (a closed angle). Indeed, in a comparison of prototype axes, it was determined that an axe 10 with a blunt tip 24 angled toward the handle 12, as shown in FIG. 7, did not perform as well as an axe with a blunt tip having an open angle, like that shown in FIGS. 1-5. FIG. 8 illustrates a variation of the axe 10 of FIG. 7 with the second cutting edge 22 and blunt tip 24 flipped 180°.

In another embodiment illustrated in FIGS. 9-11, the second cutting edge 22 may have one or more edges each with a different radius or that may be straight. For example, FIG. 9 illustrates a second cutting edge 22 that has two separate cutting edges 22c and 22d. Here, the cutting edges 22c and 22d are each curved and may have the same radius but may also meet at an angle, or may have different radii, or both. FIG. 10 illustrates separate cutting edges 22c and 22d, one of which is an arc (22c) and the second of which is a straight line (22d). FIG. 11 illustrates two cutting edges 22c and 22d each being a straight line. In the embodiments shown in FIGS. 9-11 both of the cutting edges 22c and 22d may be sharpened, some portion of each may be sharpened, or just the cutting edge nearest the blunt tip 24 (22c) may be sharpened.

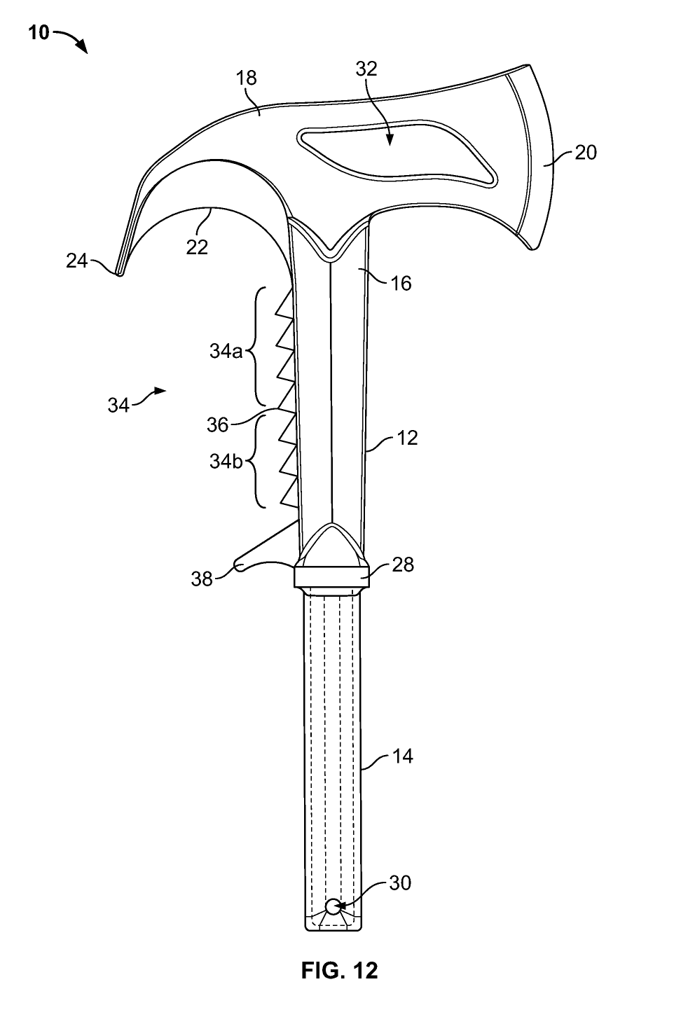

A further embodiment is shown in FIG. 12, where the axe 10 is depicted with the handle 12 including a saw 34. The saw 34 may include a plurality of teeth 36 of desired size to enable a user to cut metal, wood, bone, and the like. In another embodiment, the axe 10 may include a saw 34 having teeth 36 of one size on one side and another saw (not shown) on the opposite side of the handle 12 with teeth of the same or a different size. Further, it is envisioned, that a single saw 34 may include a first portion 34a with teeth 36 of a first size and a second portion 34b with teeth of a second size different that the first size. Furthermore, the axe 10 may include a guard 38 that may protect a user from the saw 34 or limit the stroke length of the saw to aid the user in maintaining placement of the saw on the surface being cut.

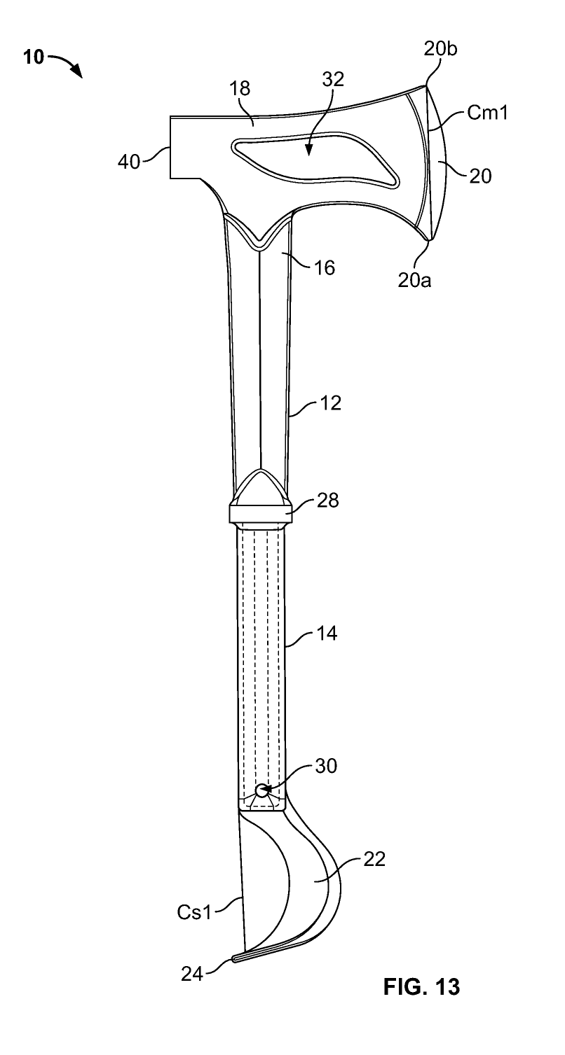

In a further embodiment shown in FIG. 13, the second cutting surface 22 and blunt tip 24 may be placed on the first end 14 of the handle 12 beneath the grip (not shown). In this embodiment, the major chord Cₛ₁ may be angled with respect to the longitudinal axis A similar to the major chord Cₘ₁. Opposite of the first cutting edge 20 may be a striking surface 40 that may be used as a hammer.

Axes 10 of the present disclosure may have the handle 12 and the head 18 formed of metal, though any suitable material or combinations of materials may be used. Examples of materials that may be used for axes 10 contemplated herein include metals, without limitation, polymers, plastics, composites, wood, carbon fiber, graphite, fiberglass, foam, rubber, leather, and combinations thereof. Metals contemplated include, among others, titanium, aluminum, steel, and alloys thereof. Further materials contemplated for use herein include polymers and metal alloys and superalloys suitable for additive manufacturing. A material may be selected, for example, based on its hardness, malleability, strength, density, and weight, among other factors.

The grip 26 may be made of any suitable material or combinations of material, such as leather, plastic, rubber, wood, foam, an elastomeric material, a vibration reducing grip material, and combinations thereof. In one embodiment, the grip material may have a Shore A durometer of from about 40 to about 80, or about 50 to about 75, or about 63 to about 73, or about 60, or about 65, or about 68. Grip materials contemplated for use also include those disclosed in U.S. Pat. No. 6,465,535.

### INDUSTRIAL APPLICABILITY

The axes disclosed herein provide improved durability, convenience of use, and an easier to clean tool for hunters while providing a plurality of tools for their use.

Numerous modifications will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the application are reserved. All patents and publications are incorporated by reference. All values and ratios disclosed herein may vary by±10%, ±20%, or ±40%.

We claim:

1. An axe, comprising:
a handle having a first end, a second end, and a longitudinal axis; and
a head disposed on the second end, the head comprising a first cutting edge having a first chord having an angle of about 45° or less from the longitudinal axis;
a second cutting edge having a second chord having an angle of between about 45° to about 135° from the longitudinal axis,
wherein the second cutting edge is capped at an outer end thereof with a blunt tip.

2. The axe of claim 1, wherein the head further comprises the second cutting edge.

3. The axe of claim 1, wherein the second cutting edge is disposed on the first end of the handle.

4. The axe of claim 1, wherein the head and the handle are comprised of a single piece of at least one of titanium, aluminum, steel, and alloys thereof.

5. The axe of claim 1 further comprising a grip disposed on the first end of the handle, wherein the grip comprises leather, plastic, rubber, wood, foam, an elastomeric material, a vibration reducing grip material, or combinations thereof.

6. The axe of claim 1, wherein the first cutting edge has a convex edge and the second cutting edge has a concave edge.

7. The axe of claim 6, wherein the first cutting edge has a radius of greater than about 2.5 centimeters and the second cutting edge has a radius ranging from about 1 to about to about 15 centimeters.

8. The axe of claim 1, wherein the blunt tip is angled relative to the longitudinal axis from about 0° to about 45°.

9. The axe of claim 1, wherein the blunt tip is angled back toward the handle.

10. The axe of claim 1, wherein the blunt tip has a rounded end.

11. The axe of claim 1 further having a ratio of an overall length of the tool to a chord length G_{L} of the second edge ranging from about 2 to about 40.

12. The axe of claim 1 further having a ratio of the chord length of the first edge to the chord length of the second edge of about 2 or greater.

13. An axe, comprising:
a handle having a first end, a second end, and a longitudinal axis; and
a head disposed on the second end, the head being integral with the handle and comprising:
a first cutting edge having a first chord with an angle of about 45° or less relative to the longitudinal axis,
a second cutting edge having a second chord with an angle of between about 45° and about 135° relative to the longitudinal axis,
wherein the first chord has a length L_{cmm 1} measured between a first end and a second end of the first cutting edge of about 2.5 to about 15 centimeters, and the second chord has a length G_{L} between a first end and a second end of the second cutting edge ranging from about 0.25 L_{cm1} to about 0.71 L_{cm1}.

14. The axe of claim 13 further comprising a transverse hole through the head.

15. The axe of claim 13, wherein the first cutting edge is disposed on a first end of the head and the second cutting edge is disposed on a second end of the head.

16. The axe of claim 13, wherein the first chord has a length L_{cm1} of about 15 centimeters, and the second chord has a length of about 0.7 L_{cm1}.

17. The axe of claim 13, wherein the first chord has an angle of about 15° or less from the longitudinal axis and the second chord has an angle of between about 80° to about 100° from the longitudinal axis.

18. An axe, comprising:
a handle having a first end, a second end, a longitudinal axis, and a saw along one side thereof; and
a head disposed on the second end, the head comprising:
a first cutting edge having a first chord with an angle of about 45° or less relative to the longitudinal axis, and
a second cutting edge having a second chord with an angle of between about 45° and about 135° relative to the longitudinal axis.

19. The axe of claim 18 further comprising a guard.

20. The axe of claim 19, wherein the guard is disposed on the handle between the saw and a grip.
